(19) United States
(12) Patent Application Publication
(10) Pub. No.: US 2018/0315073 A1
(43) Pub. Date: Nov. 1, 2018

(54) REBATE AUTOMATION METHODS AND SYSTEMS

(71) Applicant: US Beverage Net Inc., Syracuse, NY (US)

(72) Inventors: Mark E. Young, Syracuse, NY (US); Sundar Ravindran, Syracuse, NY (US)

(21) Appl. No.: 15/967,907

(22) Filed: May 1, 2018

Related U.S. Application Data
(60) Provisional application No. 62/492,538, filed on May 1, 2017.

(51) Int. Cl. G06Q 30/02; G06Q 20/20

(52) U.S. Cl. CPC G06Q 30/0234; G06Q 20/202; G06Q 20/10; G06Q 30/0226; G06Q 30/0225

(57) ABSTRACT

Methods and systems for rebate automation. In one embodiment sales check data comprising a check identifier, a point of sale identifier and a product identifier is inputted using a consumer user interface. One of a plurality of rebate offers matching the point of sale identifier and the product identifier of the sales check data is selected. The selected rebate offer comprises a rebate identifier and a reward value. Using the consumer user interface, the check identifier and the rebate identifier is submitted for validation to a rebate server to initiate accrual of the reward value. In another embodiment, a system for rebate automation includes a device with a consumer user interface, a rebate server and a point of sale system.

### CROSS-REFERENCE TO RELATED APPLICATION(S)

This application claims priority to U.S. Provisional Patent Application Ser. No. 62/492,538 filed May 1, 2017, which is incorporated herein by reference in its entirety.

### BACKGROUND

In a three-tier business model, in which a product is produced or managed by a distributor and sold to a consumer user through a retail establishment, control of consumer rebates by the distributor can be challenging. For example, the distributor may desire to offer rebates to particular consumers to enhance sales through a particular retail channel, without offering rebates for the same products or consumers through different retail channels. Such a situation may develop when the distributor is attempting to launch new product lines through new channels. In another example, a particular retailer may desire to offer promotions to different consumers by catering to the consumers tastes. Conventional methods of offering consumer rebates do not directly tie together distributor, retailer and consumer data.

### SUMMARY

Presented herein, in one aspect, is a method for rebate automation. In one embodiment sales check data comprising a check identifier, a point of sale identifier and a product identifier is inputted using a consumer user interface. One of a plurality of rebate offers matching the point of sale identifier and the product identifier of the sales check data is selected. The selected rebate offer comprises a rebate identifier and a reward value. Using the consumer user interface, the check identifier and the rebate identifier is submitted for validation to a rebate server to initiate accrual of the reward value.

In another embodiment, a plurality of rebate offers is sent to a consumer user interface associated with a user. One rebate offer of the plurality of rebate offers comprises a rebate identifier, a point of sale identifier, a product identifier and a reward value. The rebate identifier of the one rebate offer and a check identifier is received from the consumer user interface. The check identifier is validated with a point of sale system to confirm that sales check data associated with the check identifier includes the point of sale identifier and the product identifier of the one rebate offer. The reward value of the one rebate offer is accrued to a rewards account balance of the user.

In another aspect, a system for rebate automation is presented. The system includes a device with a consumer user interface, a rebate server and a point of sale system. The consumer user interface configured to receive a plurality of rebate offers, input sales check data comprising a check identifier, a point of sale identifier and a product identifier, and select one of the plurality of rebate offers matching the point of sale identifier and the product identifier of the sales check data. The selected rebate offer further comprises a rebate identifier and a reward value. The consumer user interface further submits for validation the check identifier and the rebate identifier. The rebate server is configured to accrue the reward value of the one rebate offer to a rewards account balance of the user. The point of sale system is configured to validate the check identifier to confirm that sales check data associated with the check identifier includes the point of sale identifier and the product identifier of the one rebate offer.

The techniques described herein may be implemented through a combination of a centralized server and remote mobile applications. For example, a distributor deployed server may aggregate data from multiple retail outlets. Such data may include point of sales data, average selling price data, etc. The server may initiate or triggered a rebate based on the data. The rebate may be delivered to a consumer via a mobile application (e.g., an “app”).

### BRIEF DESCRIPTION OF THE SEVERAL VIEWS OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the disclosed subject matter encompasses other embodiments as well. The drawings are not necessarily to scale, emphasis generally being placed upon illustrating the features of certain embodiments of the invention. In the drawings, like numerals are used to indicate like parts throughout the various views.

FIGS. 1-3 are high-level flowcharts of an automated rebate system, in accordance with one or more aspects set forth herein;

FIG. 4 is a high-level flowchart of a system for sharing rebates, e.g., the rebates described in FIGS. 1-3, in accordance with one or more aspect set forth herein;

FIGS. 5A-5D is a high-level flowchart of a system for redemption of rebates, e.g., the rebates described in FIGS. 1-4, in accordance with one or more aspects set forth herein;

FIG. 6 is a high-level flowchart of a system for triggering rebates, e.g., the rebates described in FIGS. 1-5D, in accordance with one or more aspects set forth herein;

FIG. 7 is a high-level flowchart of a system for verifying rebates, e.g., the rebates described in FIGS. 1-5D; and

FIGS. 8A-8H are graphical user interfaces, in accordance with one or more aspects set forth herein.

### DETAILED DESCRIPTION

Described herein are systems, methods and techniques for enabling end-to-end automated rebate and customer loyalty programs. Advantageously, the techniques described herein relate to a fully automated system that brings together customer data, distributor data, retail data, and other data to provide integrated programs that may be implemented without manual scanning and entry of information.

For instance, the techniques described herein may provide an advantage to promote sales of well-accepted and often consumed products and also allow for increasing the sales of a sluggish product line by targeting consumers likely to purchase the products and offering incentives to those consumers. As another advantage, the methods and systems described herein enabled the launch of new products, by allowing targeted information to be delivered to potential consumers. Such targeted information may allow the users to sample the products at a reduced price or to obtain loyalty points by trying the new products. As a further advantage, the rebate and incentive programs described herein may be funded through a combination of manufacturer, distributor, and retailer funds. Because the rebates and incentives are delivered directly to a consumer, manufacturers and distributors may be insured that marketing dollar spent on such rebates are effectively deployed.

In another example usage scenario, a consumer may visit one location of a restaurant chain. The consumer may receive a rebate offer promotion, which may allow redemption at the visited location or any geographic location of the chain restaurant, and may allow redemption of a specific brand of beer or any brand of beer. Advantageously, the system and methods described herein allow for different types of targeted marketing. For instance, consumers may be given incentives to visit specific geographic locations, such as the original location visited by the consumer in the above example to increase repeat business, or a different location for which consumer traffic is desired, for instance, another location of the same restaurant chain that the consumer has not yet visited. Other locations may be selected on the basis of multiple geographical addresses maintained for a given user, for example a home address and a work address, and the system facilitates incenting a consumer to broaden his or her visits on a geographical basis. In addition, as noted in the specific example above, the same or different products may be the subject of the promotions or rebates offered, again depending on the type of consumer behavior that is being encouraged. For example, there may be a desire to offer promotions for a different beer in the same brand family, or a different beer in a different brand family, depending on the promotions that are being offered. The system and methods herein facilitate the creation of such promotions that are based on multiple factors, including geography, retail outlet genre, brands, etc.

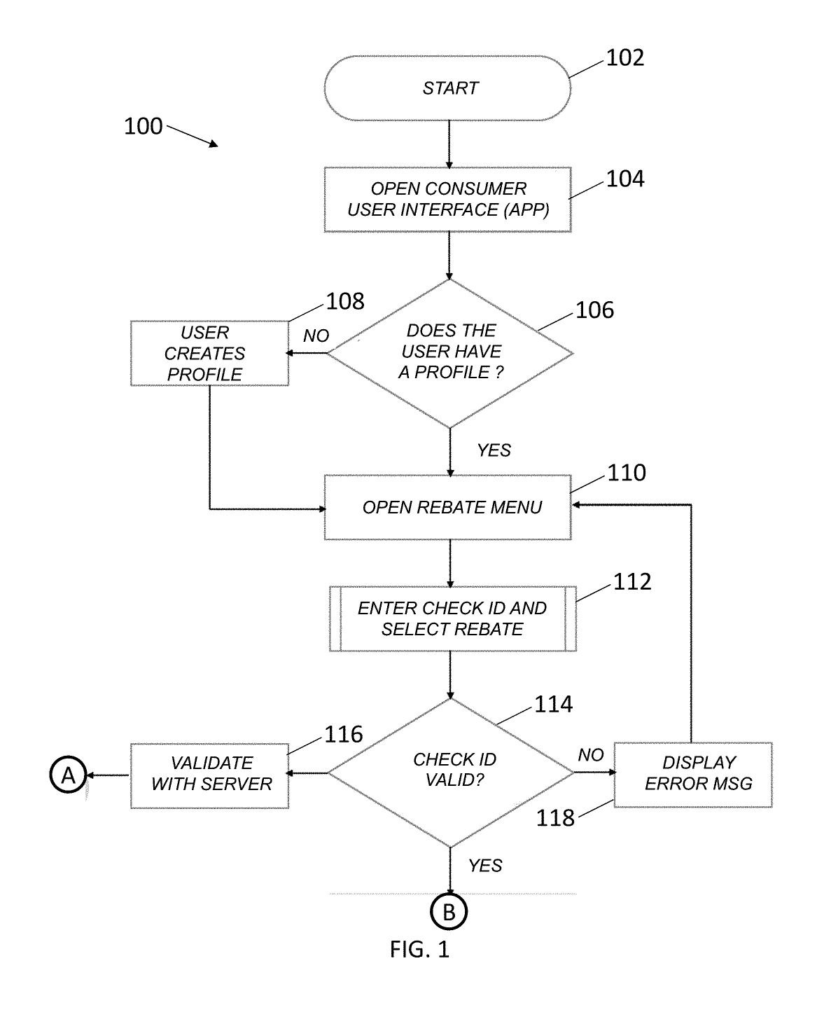

FIGS. 1-3 are flowcharts describing an automated rebate program system 100. In the exemplary embodiment, the system allows a user to earn and redeem rebates for beer (i.e., the rebate offers are colloquially called “beer chips”) at a variety of retail locations. A rebate offer can represent a free or discounted beer that is available at a specific retail location, such as a bar or restaurant. Further details and example graphical user interface screens are set forth herein in Appendix A and Appendix B. In addition, certain details of the server systems, data collection, and other aspects of the present technique are described in further detail in U.S. Pat. No. 8,458,312 B2, entitled DISTRIBUTED INTELLIGENT SYSTEMS AND METHODS THEREFOR, which is hereby incorporated by reference in its entirety herein.

As illustrated in FIG. 1, at block 104 a user may open a beer board application, having a consumer user interface, for example on a smart phone, laptop, or other device. The application with the consumer user interface may communicate with a centralized server over a computer network. After opening the application, at block 106 the application can check for a user profile affiliated with the user. If the user does not have a profile, at block 108, the user may create a profile. Otherwise if the user does have a profile, the program logic may proceed to block 110. At block 110, a rebate offers menu may be opened by the user. The rebate offers menu can list rebate offers that are available to the user.

For example, a rebate offer may be for a specific brand of beer available at a specific retail location. The user can peruse the different available rebate offers, and may visit one of the retail locations to take advantage of the available promotion.

Continuing with FIG. 1, at block 112, a user may select a rebate offer for redemption using sales check data, including a check ID, point of sales identifier, and the potential reward value. For example, the user may have visited a retail location and ordered a beer subject to one of the promotions listed in the rebate offers menu at block 110. Subsequently, after paying for the order, the user may receive a check or receipt with a unique identifier which identifies the transaction. The transaction may have been uploaded by the store's point of sales system to a centralized database that is accessible to system 100. Then, at block 112, the user may enter the check ID into the application in order to redeem the rebate offer. The system 100 at block 114 determines if the check ID is valid, by performing verification logic at block 116, which continues at block A. If the check ID is not valid, the system 100 may return to block 110 and display the rebate offers menu to the user. If the check ID is valid, the program logic may continue at block B. Conversely, the consumer user may review a plurality of rebate offers before deciding which retailer to dine at. Based on the best rebate offers, the user can then select the dining establishment.

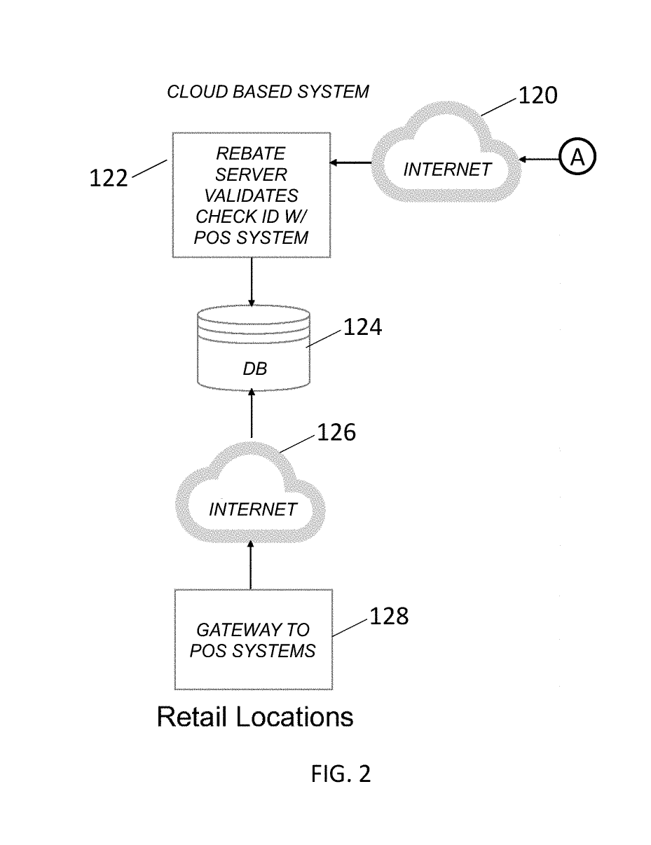

Turning next to FIG. 2, the check ID verification program logic at block 116 continues at block A. The program logic connects via the internet 120 to server(s), such as a U. S. Beverage Network server. At block 122, the server(s) validate the check ID with the information from the retail location's point of sale (POS) system stored in database 124. For example, at block 128, a gateway located at the retail location may have previously sent a point of sales check information datagram to the database 124, allowing the program logic at block 122 to perform the verification. The database 124 can support numerous point of sales gateways uploading their check information.

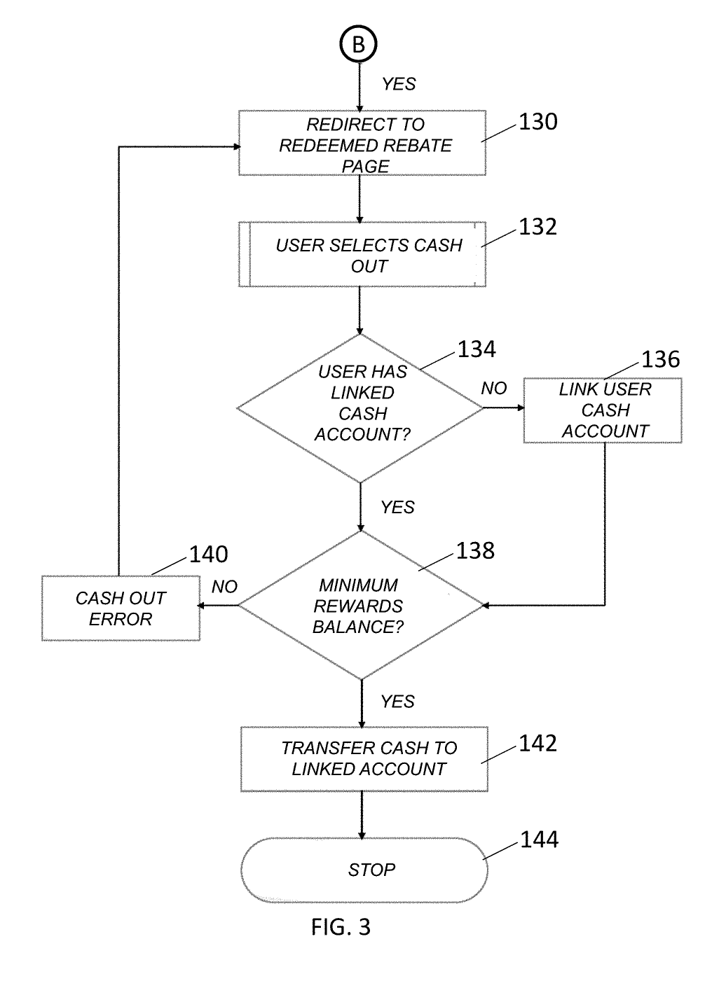

Next, with respect to FIG. 3, the program logic continues at block B, after the verification logic at block 116 (see FIG. 1) has verified the check ID affiliated with the rebate offer redeemed by a customer. The user application at block 130 can redirect the user via a graphical user interface to a rebate offers redemption page. The rebate offer redemption page can indicate all rebate offers that have been previously redeemed, including the rebate offer that was verified at block 116.

The user may cash out at block 132. First, the system at 134 may determine if the user has a payment account that is linked to the system 100. For example, a PayPal or Venmo account may be used. If the user does not have such an account set up, the system 100 can allow the user to link such an account at block 136. The program logic at block 138 determines if the amount of rebate offers to be cashed out exceeds a predetermined minimum amount, such as $20. If it does not, the program logic at block 140 may display an error message, and the system may return the user (e.g., via the graphical user interface on the application) to block 130 and display the redemption screen. If the amount to be cashed out is sufficient, the system 100 at block 142 may transfer the amount of money to the user's linked account (as determined at block 134).

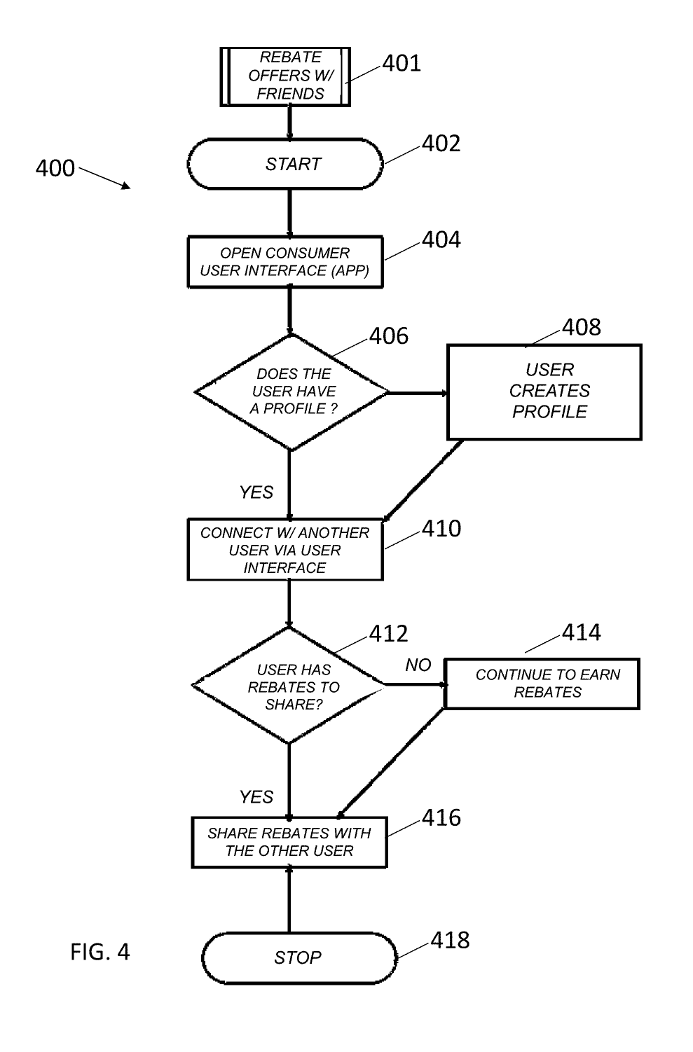

FIG. 4 is a high-level flowchart of a method 400 for sharing rebates, e.g., the rebates described in FIGS. 1-3, in accordance with one or more aspect set forth herein. In one aspect, the method 400 may run on a distributor deployed server. For instance, the method 400 at block 401 may include a sub routine for sharing so called rebate offers between a user and friends of the user. The method 400 at block 402 may start responsive to a user opening a mobile application, or initiated by a trigger from a distributor or retail outlet.

Continuing with the embodiment of FIG. 4, the method 400 at block 404 opens a beer board menu on, for example, a smartphone application of a user. Next, the method 400 at block 406 determines whether a user has a beer board menu account. If the user does not have a beer board menu account, the method 400 at block 408 allows the user to create a beer board menu account. If the user already has a beer board menu account, the method 400 at block 410 connects the user with other beer board menu users by a menuing system. For example, the user may have previously linked with other friends who also have accounts in the system. Next, the method 400 at block 412 determines whether the user has rebate offers or other items to share. For example, the user may have rebate offers to redeem free beverages or other products, or loyalty points. If the user has something to share with a friend the method 400 at block 416 allows for those rebate offers or other items to be shared and deposited in accounts maintained for the friends within the system. The method 400 at block 414 allows the users to participate in programs to earn further rebate offers. The method 400 at block 418 may stop the sharing process and return the user to a main menu.

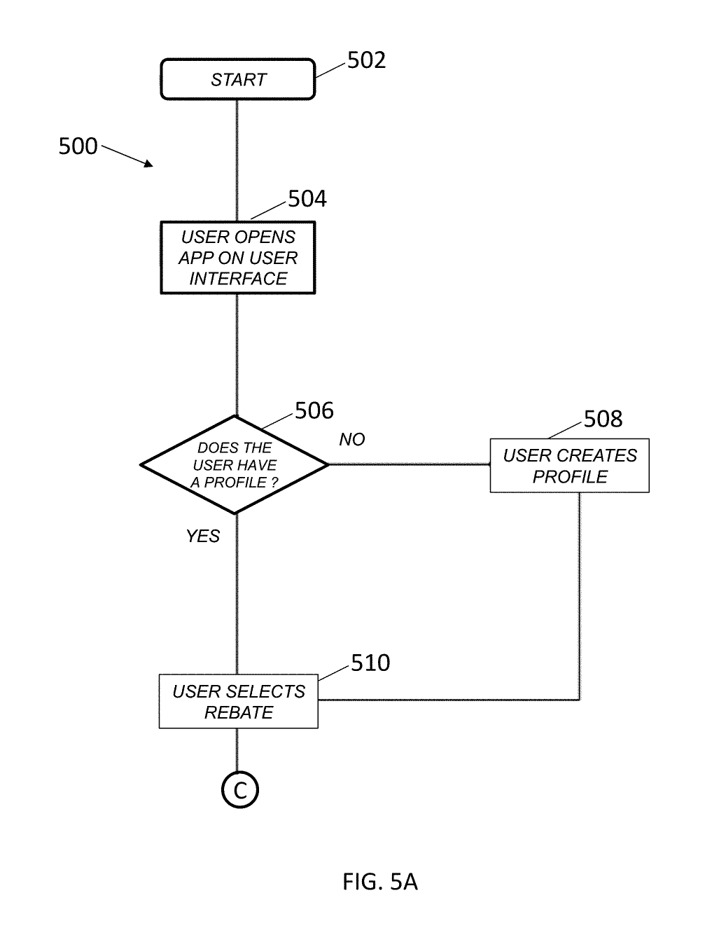

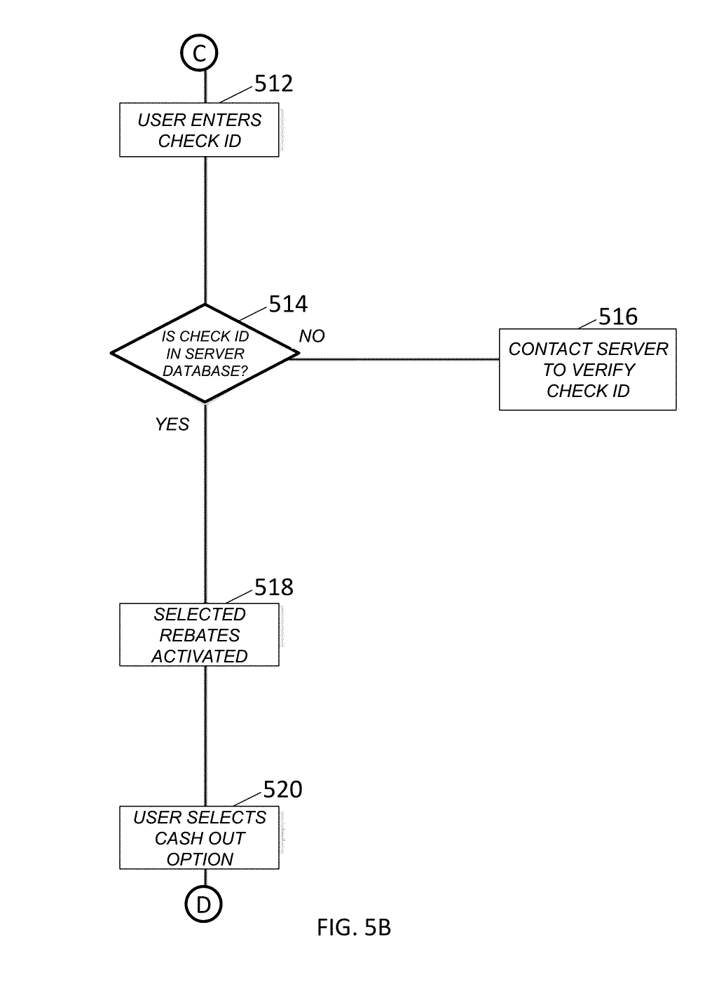

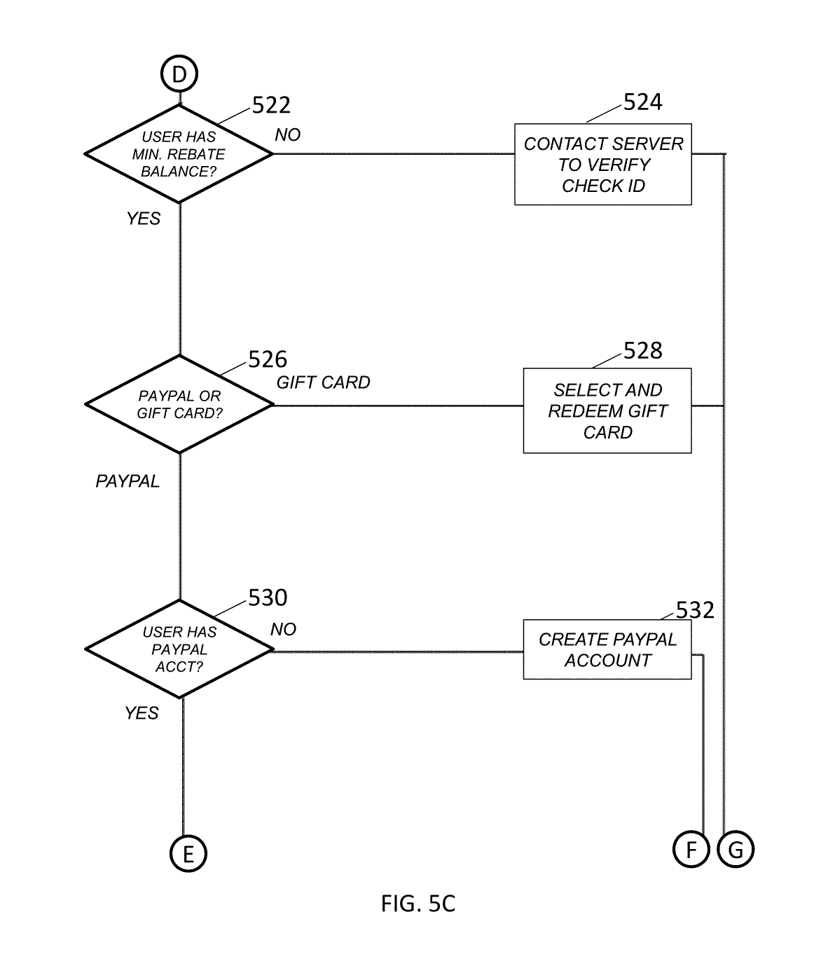

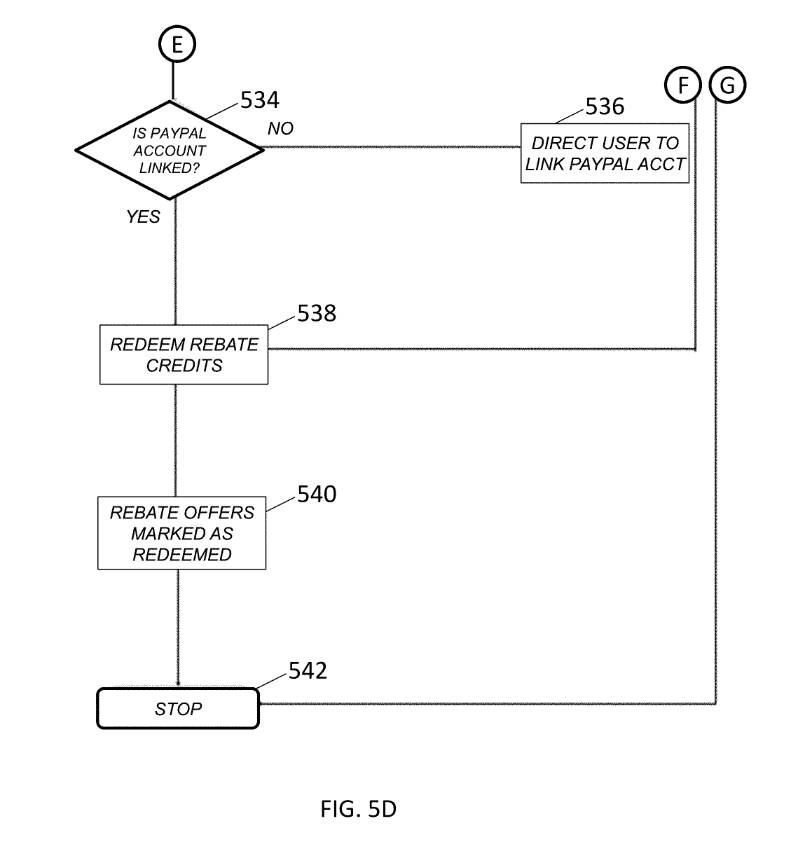

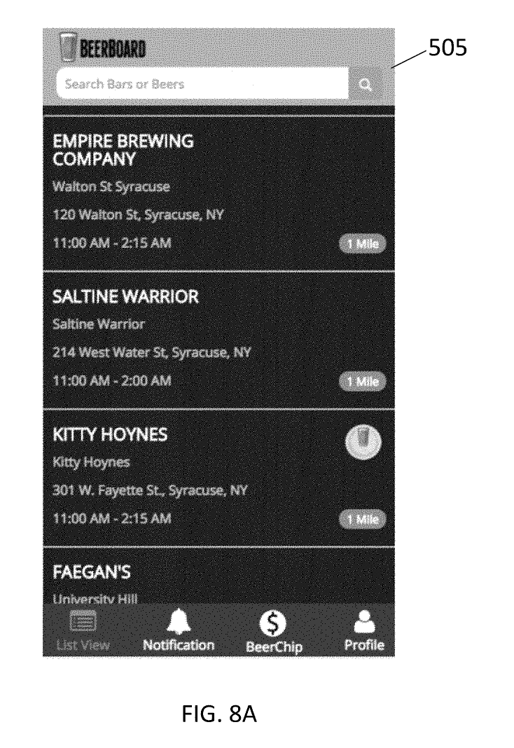

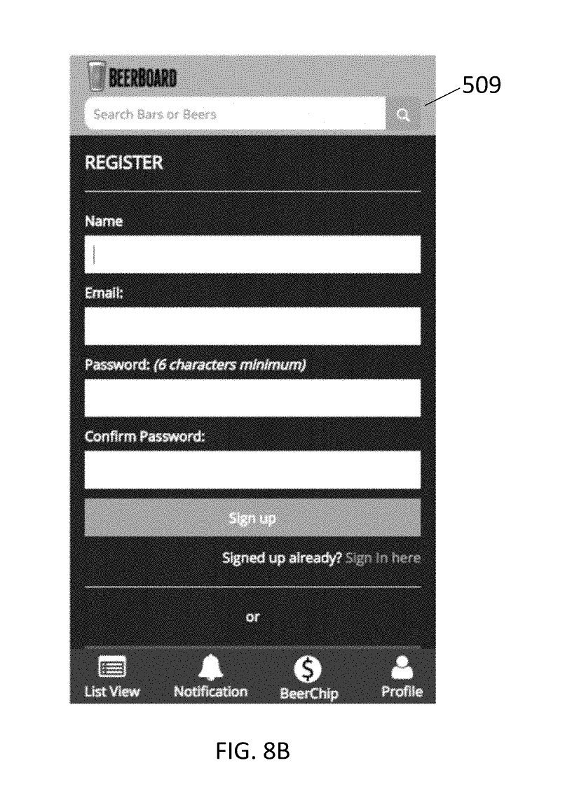

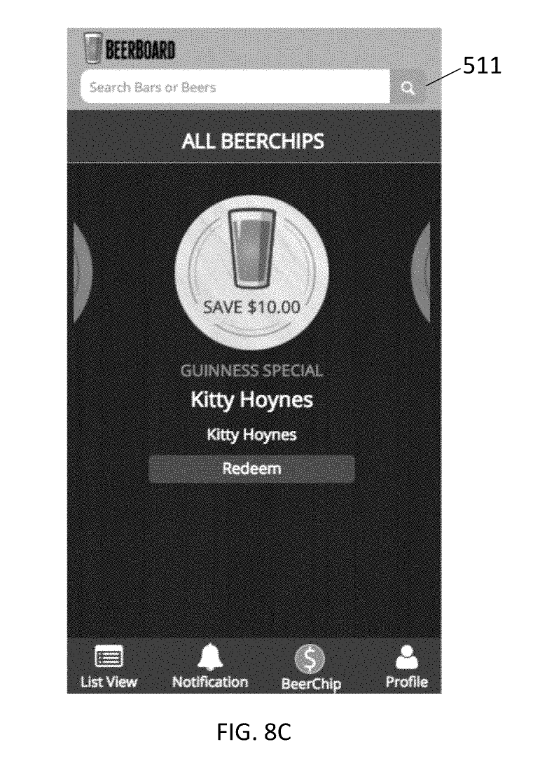

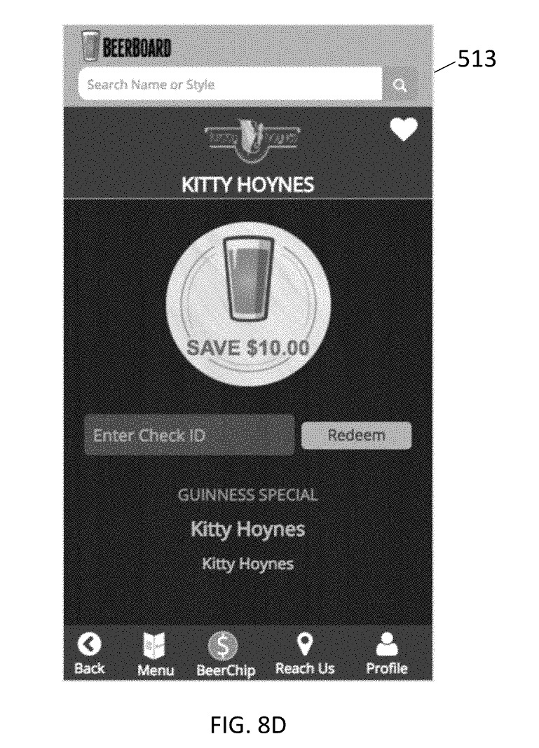

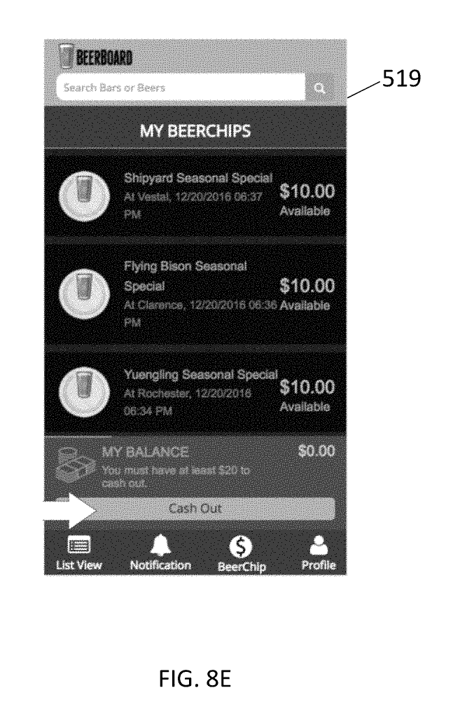

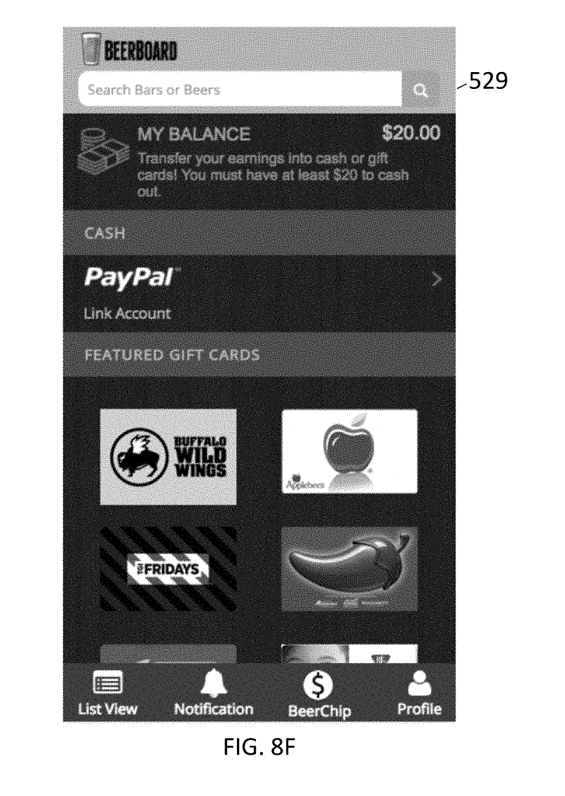

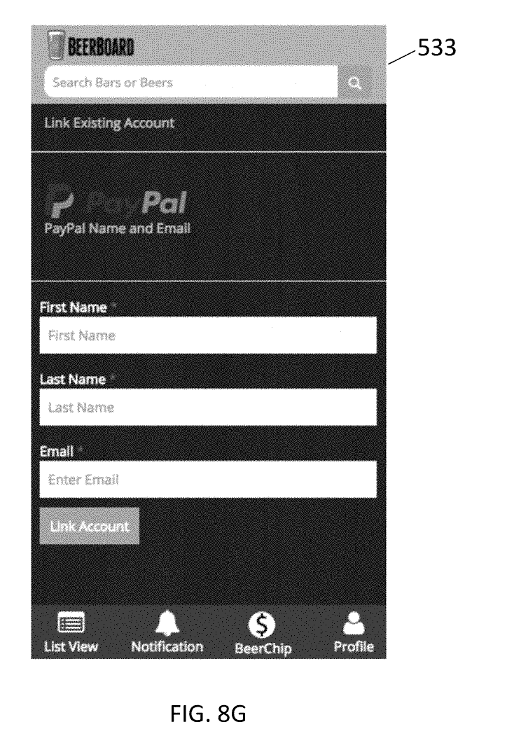

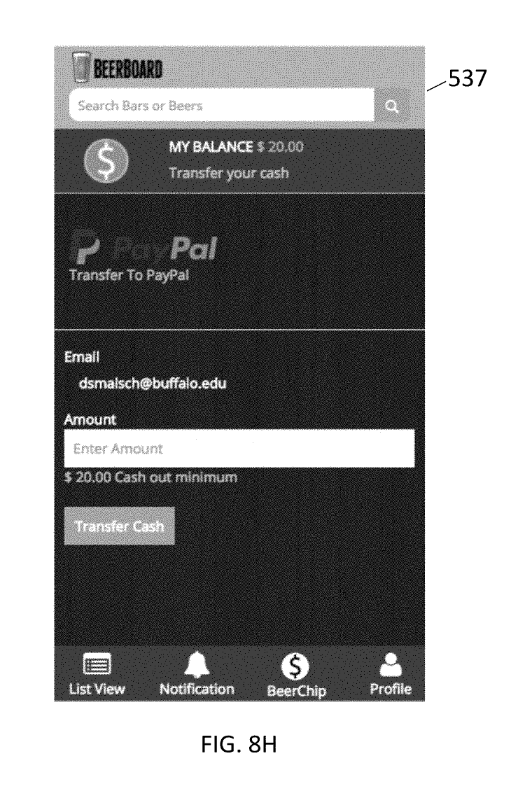

FIGS. 5A-5D is a high-level flowchart of a method 500 for redemption of rebates, e.g., the rebates described in FIGS. 1-4, in accordance with one or more aspects set forth herein. For instance, the method 500 at block 502 may start the redemption process responsive to a user selection in a mobile act. Next, the method 500 at block 504 allows the user to open a beer board menu application. For example, a graphical user interface 505 (see FIG. 8A) may be displayed to the user. The graphical user interface 505 may depict a listing of different rebates that may be selected by the user for redemption. Continuing with the embodiment of FIG. 5A, the method 500 at block 506 determines whether the user has a profile within the beer board system. If the user does not have a profile, the method 500 at block 508 allows the user to create a new account. For example, graphical user interface 509 (see FIG. 8B) may be used by the user to register by providing a name, email address, password, and other pertinent information. If the user does have a profile, the method 500 at block 510 allows the user to select the beer chip or rebate offer that the user would like to redeem. For example, a graphical user interface 511 (see FIG. 8C) may display each of the rebate offers or beer chips. Some of the rebate offers or beer chips may include free beverages or other products. Other rebates may include discounts in an absolute dollar or percentage basis. The method 500 then proceeds to block C, as described with respect to FIG. 5A.

Continuing with the exemplary redemption process, the method 500 at block 512 allows the user to enter information to validate or redeem the rebate. For example, a graphical user interface 513 (see FIG. 8D) may allow the user to enter a check ID. In another example, the method 500 at block 512 may allow the user to scan a check or object using a camera of the mobile device in order to facilitate an expedited validation. Next, the method 500 at block 514 checks the database stored in the centralized server to see if the check ID or other information is present for validation purposes. If, for example, the check ID is not present in the beer board database, the method 500 at block 516 may initiate check ID verification. In one example, the check ID may be verified by the server contacting point of sales devices located at a retail outlet, and retrieving check ID's. On the other hand, if the check ID is in the database, the method 500 at block 518 allows the selected rebate offers to be available. For example, a graphical user interface 519 (see FIG. 8E) may now display the rebate offers so that the user may select and redeem them. In one example, the user may select and redeem more than one rebate offer at a time. In such a case, with reference to the graphical user interface 519, the method 500 at block 520 may allow the user to select multiple rebates and cash out. The method 500 then proceeds to block D, as described with respect to FIG. 5C.

In one aspect of the present technique, the rebates may accumulate in the form of cash values. In such a case, the method 500 at block 522 may determine whether the user has a sufficient cash balance to justify or enable cashing out the rebate, to avoid small micro payments that may be burdensome on the system due to volume or transaction fees. If the user does not have a sufficient balance, the method 500 at block 524 may notify the user is sufficient balance does not exist and return at block G.

If the user does have a sufficient balance, the method 500 at block 526 may allow redemption of the balance in one of many different manners. For example the method 500 at block 528 may allow redemption in the form of a gift card. In such a case the user may select a desired establishment and redeem the credits for gift card to that establishment. An example of gift card redemption is set forth in a graphical user interface 529 (see FIG. 8F). In another example, the method 500 at block 530 may allow for a cash payment to be forwarded to the user. For example, the user may have a payment account through PayPal or another financial institution. In such a case, the method may proceed to block E, as described with respect to FIG. 5D. otherwise, the method 500 at block 532 may allow the user to create a new account. For example, a graphical user interface 533 (see FIG. 8G) may allow the user to create a PayPal or other account, and return to block F, as described with respect to FIG. 5D.

Continuing next with respect to FIG. 5D, the method 500 at block 534 may additionally determine whether a financial account is linked to the system. If the financial account is not linked, the method 500 at block 536 may direct the user to link the financial account. Assuming that the financial account has been linked, the method 500 at block 538 redeems the rebate offer credits for deposit within the financial account, such as a PayPal account. For example, a graphical user interface 537 (see FIG. 8H) may allow the user to select and validate the financial account to receive the funds. Next, the method 500 at block 540 marks the rebate offers as having been redeemed. The method 500 at block 542 then stopped the redemption process and returns to the main routine, such as a main screen in the mobile application allowing the user to continue to earn credits.

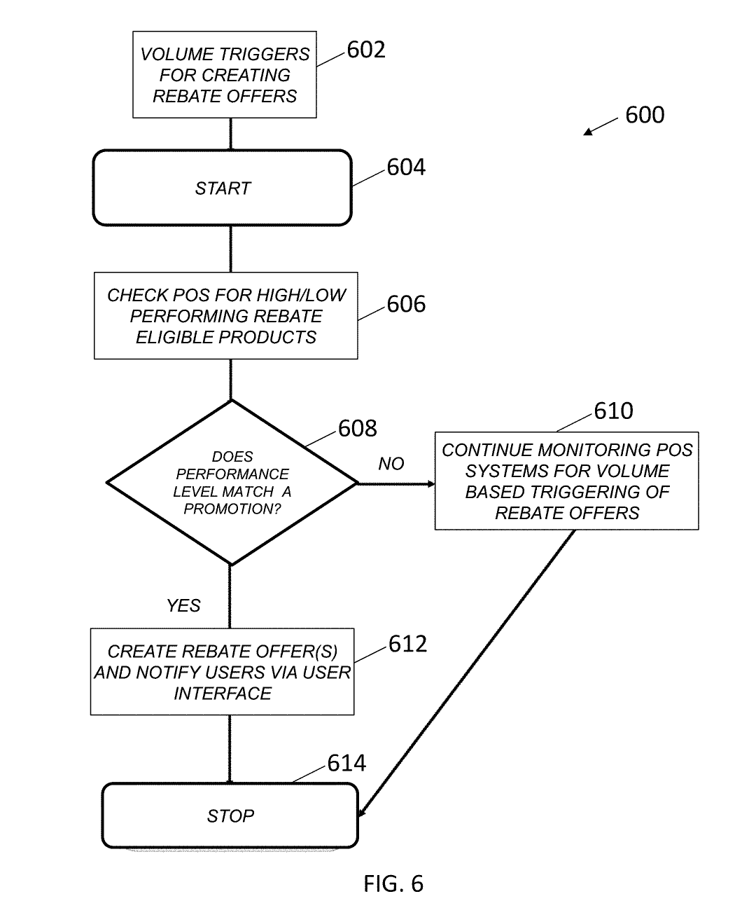

FIG. 6 is a high-level flowchart of a method 600 for triggering rebates, e.g., the rebates described in FIGS. 1-5D, in accordance with one or more aspects set forth herein. In one embodiment, the method 600 at block 602 allows for a volume trigger sub routine to be entered. The method 600 at block 604 starts a sub routine. The method 600 at block 606 performs a check for high or low performing products such as beers at given stores or markets. The performance checks may be done on a store by store basis, a geographical basis, or based on other preprogrammed performance metrics. For example, the distributor may create a target list of sales goals for each store and each product at each store. In such a case, the method 600 at block 606 can retrieve real time sales information from the retail outlets and compared such information with the targeted sales goals on an ongoing basis. Next, the method 600 at block 608 determines whether the sales volume information complies with one or more existing promotions that have been defined within the system. If the sales information that has been retrieved does not justify the creation of new promotions, the method 600 block 610 continues to monitor the various retail locations by receiving data feeds from those locations. However, if the sales information does justify the creation of new promotions, the method 600 at block 612 creates a new promotion such as a rebate offer, and notifies the rebate offer users. For example a mobile application alert may be sent to all users, who may then take advantage of the promotion. The method 600 at block 614 then completes the triggering routine, and may return to block 602 to continue monitoring data received from retail outlets, users as rebate offers are redeemed, etc., so that new promotions may be initiated, for example, at block 612.

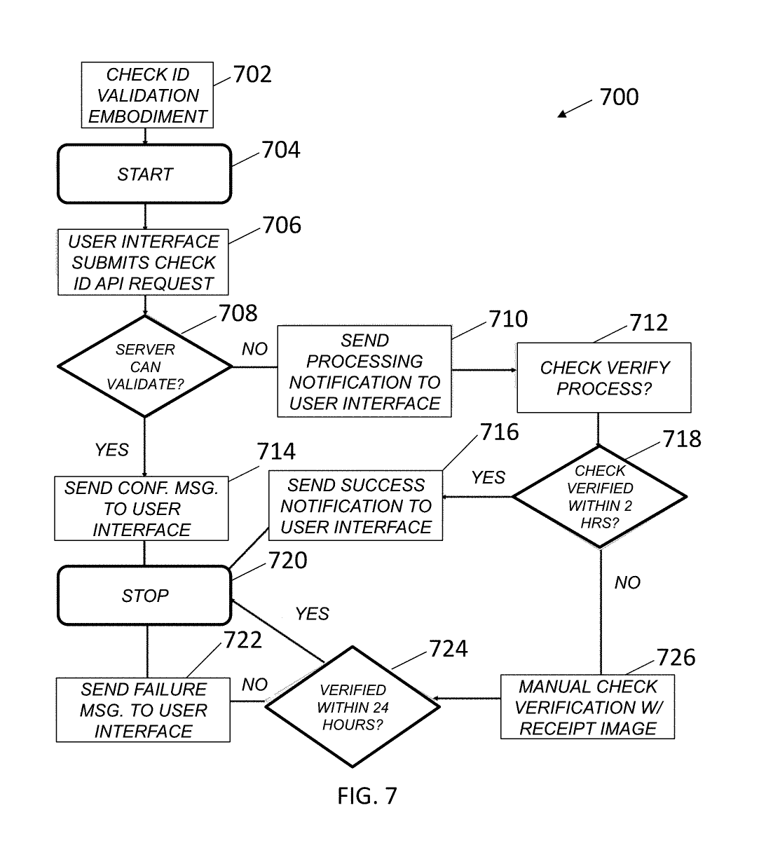

FIG. 7 is a high-level flowchart of a method 700 for verifying that rebates should be paid, for example, by verifying check IDs. For instance, the method 700 at block 702 may allow initiation of a check IDs verification sub routine, and start the method 700 at block 704. Next, the method 700 at block 706 receives an application programming interface request to verify a check ID from one of the many mobile applications that have been installed by the various users of the system. The method 700 at block 708 determines whether the server system have the check identification information to validate the check ID. If not, the method 700 at block 710 sends a processing notification to the mobile application explaining that the receipt will be saved until a later time, because the check ID has yet to be received from one of the retail locations, preventing verification. In such a case, the method 700 at block 712 may initiate a 30 minute check verification process, allowing time for the retail location to upload various check IDs to the system. The method 700 at block 718 may continue the verification process over a two-hour period. The method 700 at block 716 may send a success message to the mobile application upon successful verification of the check ID.

If, on the other hand, the system already have the check ID information, the method 700 at block 714 sends a confirmation message to the mobile application to that effect. In a circumstance in which the check ID may not be verified automatically, the method 700 at block 726 allows for manual verification of the check using an image of the receipt. The method 700 at block 724 can continue to verify through manual processes for a period of time, such as 24 hours. If verification is not possible, the method 700 at block 722 may send a failure notification to the mobile application.

Although the examples herein are given in terms of beer and bars/restaurants, similar concepts may be used in other industries, to manage promotions for food, other consumer products, services, etc.

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof “At least one of element A, element B, and element C” is not intended to be limited to at least one of an element A, at least one of an element B, and at least one of an element C.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

As will be appreciated by one skilled in the art, aspects of the present invention may be embodied as a system, method or computer program product.

Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

What is claimed is:

1. A rebate automation method comprising
inputting, using a consumer user interface, sales check data comprising a check identifier, a point of sale identifier, and a product identifier;
selecting, using the consumer user interface, one of a plurality of rebate offers matching the point of sale identifier, and the product identifier of the sales check data, the selected rebate offer comprising a rebate identifier and a reward value; and
submitting for validation, using the consumer user interface, the check identifier and the rebate identifier to a rebate server to initiate accrual of the reward value.

2. The method of claim 1, further comprising receiving, from the rebate server, a reward account balance.

3. The method of claim 2, further comprising redeeming the reward account balance from the rebate server.

4. The method of claim 3, wherein the redeeming comprises initiating an electronic funds transfer.

5. The method of claim 3, wherein the redeeming comprises receiving a coupon code.

6. The method of claim 1, wherein the consumer user interface is displayed on a screen of a mobile electronic device, the mobile electronic device being configured for wireless communication with the rebate server.

7. The method of claim 1, wherein the consumer user interface is configured to receive the plurality of rebate offers from the rebate server.

8. A rebate automation method comprising:
sending a plurality of rebate offers to a consumer user interface associated with a user, one rebate offer of the plurality of rebate offers comprising a rebate identifier, a point of sale identifier, a product identifier and a reward value;
receiving, from the consumer user interface, the rebate identifier of the one rebate offer and a check identifier;
validating the check identifier with a point of sale system to confirm that sales check data associated with the check identifier includes the point of sale identifier and the product identifier of the one rebate offer; and
accruing the reward value of the one rebate offer to a rewards account balance of the user.

9. The method of claim 8, further comprising sending, to the consumer user interface, the rewards account balance.

10. The method of claim 9, further comprising redeeming the rewards account balance for the user.

11. The method of claim 10, wherein the redeeming comprises initiating an electronic funds transfer.

12. The method of claim 10, wherein the redeeming comprises generating a coupon code for use with the point of sale system.

13. The method of claim 8, wherein the consumer user interface is displayed on a screen of a mobile electronic device, the mobile electronic device being configured for wireless communication with the rebate server.

14. The method of claim 8, wherein rebate server us configured to send the plurality of rebate offers to the consumer user interface.

15. A system for rebate automation, the system comprising:
a device comprising a consumer user interface, the consumer user interface configured to:
receive a plurality of rebate offers,
input sales check data comprising a check identifier, a point of sale identifier, and a product identifier,
select one of the plurality of rebate offers matching the point of sale identifier and the product identifier of the sales check data, the selected rebate offer further comprising a rebate identifier and a reward value, and
submit for validation the check identifier and the rebate identifier;
a rebate server configured to accrue the reward value of the one rebate offer to a rewards account balance of the user; and
a point of sale system configured to validate the check identifier to confirm that sales check data associated with the check identifier includes the point of sale identifier and the product identifier of the one rebate offer.

16. The system of claim 15, wherein the rebate server sends the rewards account balance to the consumer interface.

17. The system of claim 16, wherein the rebate server redeems the rewards account balance at a request of the consumer user interface.

18. The system of claim 17, wherein the server initiates an electronic funds transfer.

19. The system of claim 17, wherein the server generates a coupon code for use with the point of sale system.

20. The system of claim 15, wherein the device is a mobile electronic device and the consumer user interface is displayed on a screen thereof, and the mobile electronic device is configured for wireless communication with the rebate server.
